(19) United States
(12) Patent Application Publication
(10) Pub. No.: US 2005/0287827 A1
(43) Pub. Date: Dec. 29, 2005

(54) Electric plug having rotatable prongs

(76) Inventor: Jui Chung Liao, Shulin City (TW)

Correspondence Address: CHARLES E. BAXLEY, ESQ., 90 JOHN STREET, THIRD FLOOR, NEW YORK, NY, 10038, US

(21) Appl. No.: 10/874,953

(22) Filed: Jun. 23, 2004

(51) Int. Cl. H01R 4/66

(52) U.S. Cl. 439/11

(57) ABSTRACT

An electric plug includes a receptacle, two conductor blades received in the receptacle for coupling to an electric cable, a casing, and two prongs engaged in the casing, and rotatably coupled to the conductor blades respectively, to rotatably couple the casing to the receptacle, and to allow the casing to be rotated relative to the receptacle. For example, each of the conductor blades includes an orifice and each of the prongs includes an axle rotatably engaged into the orifices of the conductor blades, to rotatably couple the prongs to the conductor blades respectively. The casing may further include a prong for grounding purposes.

### BACKGROUND OF THE INVENTION

1. Field of the Invention

The present invention relates to an electric plug, and more particularly to an electric plug having rotatable prongs rotatably disposed therein, for allowing the electric plug to be easily plugged to various sockets at different locations.

2. Description of the Prior Art

Typical electric plugs comprise two or three prongs extended therefrom, for coupling or plugging to socket openings. Normally, the prongs are solidly secured to or extended from the electric plugs, and may not be rotated relative to the electric plugs, such that the electric plugs may not be easily plugged to sockets at different locations.

For example, U.S. Pat. No. 5,213,516 to Okamoto discloses one of the typical electric plugs comprising two prongs solidly secured to or extended from the electric plugs, and may not be rotated relative to the electric plugs, and comprising another prong rotatably attached to the electric plug for selectively rotating to a working position that is parallel to the other two prongs. However, the two prongs also may not be rotated relative to the electric plugs, and thus also may not be easily plugged to sockets at different locations.

U.S. Pat. No. 5,252,081 to Hsieh et al. discloses another typical electric plug also comprising two prongs solidly secured to or extended from the electric plugs, and may not be rotated relative to the electric plugs, and comprising a slidable cover slidably attached thereto to selectively shield the prongs. However, the two prongs also may not be rotated relative to the electric plugs, and thus also may not be easily plugged to sockets at different locations.

The present invention has arisen to mitigate and/or obviate the afore-described disadvantages of the conventional electric plugs.

### SUMMARY OF THE INVENTION

The primary objective of the present invention is to provide an electric plug having rotatable prongs including rotatable prongs rotatably disposed therein, for allowing the electric plug to be easily plugged to various sockets at different locations.

In accordance with one aspect of the invention, there is provided an electric plug comprising a receptacle, two conductor blades received in the receptacle for coupling to an electric cable, a casing, and two prongs engaged in the casing, and rotatably coupled to the conductor blades respectively, to rotatably couple the casing to the receptacle, and to allow the casing to be rotated relative to the receptacle.

Each of the conductor blades includes an orifice formed therein, each of the prongs includes an axle extended therefrom, and rotatably engaged into the orifices of the conductor blades, to rotatably couple the prongs to the conductor blades respectively.

The casing includes a notch formed therein, and the receptacle includes a segment rotatably engaged into the notch of the casing. The receptacle includes two openings formed therein, and the casing includes two arms formed therein and rotatably engaged into the openings of the receptacle respectively.

The casing further includes a second prong disposed therein and extended therefrom. The receptacle includes a second conductor blade disposed therein and rotatably coupled to the second prong of the casing.

The second conductor blades include an orifice formed therein, the second prong includes an axle extended therefrom, and rotatably engaged into the orifice of the second conductor blade, to rotatably couple the second prong to the second conductor blade. The receptacle includes a recess formed therein, to receive the casing when the casing is rotated relative to the receptacle.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of an electric plug having rotatable prongs in accordance with the present invention;

FIG. 2 is another partial exploded view of the electric plug having rotatable prongs;

FIG. 3 is a partial perspective view of the electric plug having rotatable prongs;

FIG. 4 is a further partial exploded view illustrating prongs and a prong receiving casing of the electric plug;

FIG. 5 is a still further partial exploded view illustrating the prongs and the prong receiving casing of the electric plug;

FIG. 6 is a partial perspective view similar to FIG. 3, illustrating the operation of the electric plug having rotatable prongs; and

FIG. 7 is a side and partial cross sectional view illustrating the attachment of the electric plug to a socket.

### DETAILED DESCRIPTION OF THE PREFERRED EMBODIMENT

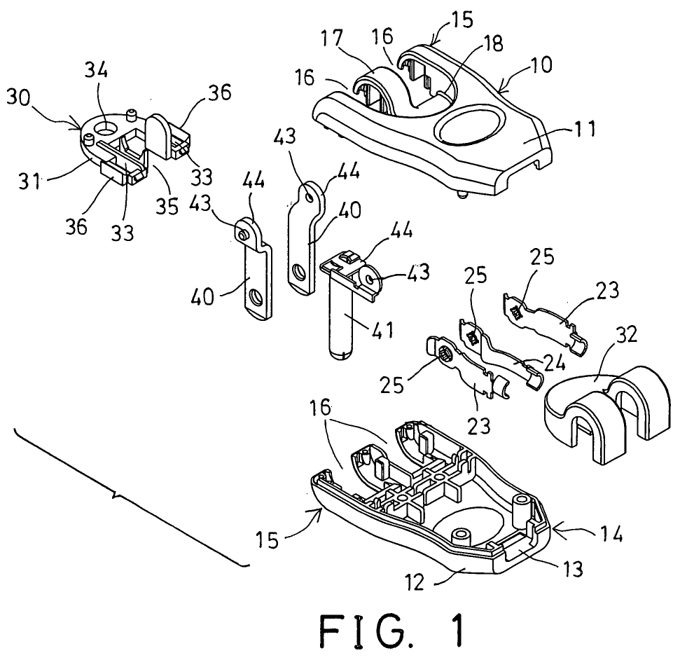

Referring to the drawings, and initially to FIGS. 1-3, an electric plug in accordance with the present invention comprises a receptacle 10 including such as two housing members 11, 12 secured together by adhesive materials, fasteners or latches (not shown), or by welding processes, and including a passage 13 formed in the rear portion 14 thereof, for receiving an electric cable 20 therein. The electric cable 20 may include two or three electric wires 21, 22 received therein.

Two or three conductor blades 23, 24 are disposed or received in the receptacle 10, as that of the typical electric plugs, and electrically coupled to the electric wires 21, 22 of the electric cable 20 respectively, in which the two side conductor blades 23 are electrically coupled to the two side electric wires 21 of the electric cable 20 respectively, and the intermediate conductor blade 24 is electrically coupled to the intermediate electric wire 22 of the electric cable 20, for example. Each of the conductor blades 23, 24 includes a projection or an orifice 25 formed therein.

The receptacle 10 includes a front portion 15 having two openings 16 formed therein and defined beside an intermediate segment 17, and having a recess 18 formed therein. For example, the recess 18 of the receptacle 10 may be formed in one of the housing members 11, and communicating with the openings 16 of the receptacle 10.

The electric plug in accordance with the present invention includes a casing 30 having a base 31, and a cover 32 attached onto the base 31. The base 31 includes two or three apertures 33, 34 formed therein, for receiving two or three prongs 40, 41 therein respectively, and each of the prongs 40, 41 includes a cavity or an axle 43 provided or extended from one end 44 thereof, for rotatably engaging with the orifices 25 of the conductor blades 23, 24 respectively, and thus for rotatably attaching the conductor blades 23, 24 and the casing 30 to the receptacle 10.

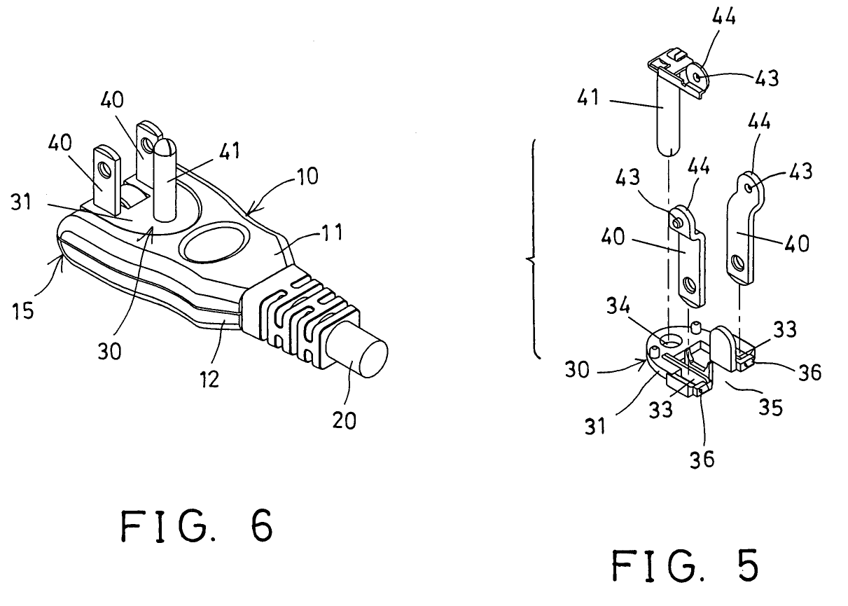

The cover 32 of the casing 30 may be attached or secured onto the base 31, and may engage with the prongs 40, 41, to stably retain or anchor the prongs 40, 41 within the casing 30. The casing 30 includes a notch 35 formed therein (FIGS. 1, 5), and defined between two arms 36. The arms 36 may be engaged into the openings 16 of the receptacle 10 respectively, and the intermediate segment 17 of the receptacle 10 may be engaged into the notch 35 of the casing 30, to allow the prongs 40, 41 to be rotatably engaged or coupled to the conductor blades 23, 24 respectively.

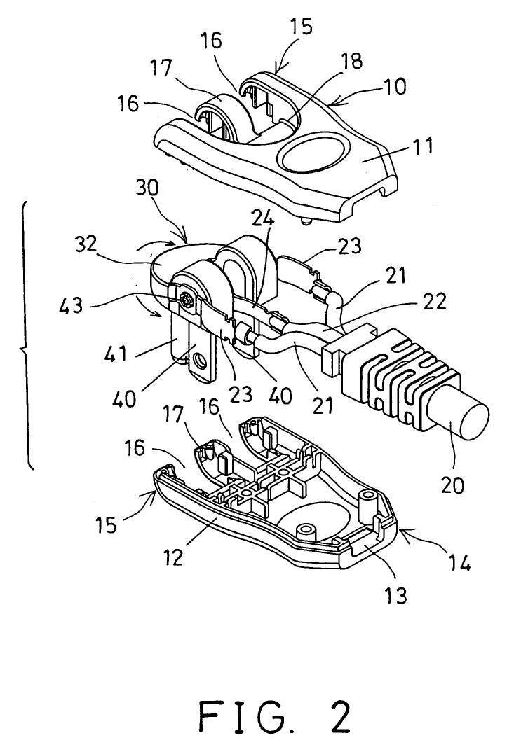

After assembling, as shown in FIGS. 2 and 4, the prongs 40, 41 may thus be electrically and rotatably engaged or coupled to the conductor blades 23, 24 respectively, and the conductor blades 23, 24 may be electrically engaged or coupled to the electric wires 21, 22 respectively, and the electric wires 21, 22 may be electrically coupled to electric power sources, for allowing the electric energy to be supplied to the prongs 40, 41 when the prongs 40, 41 and the casing 30 are rotated relative to the conductor blades 23, 24 and the receptacle 10.

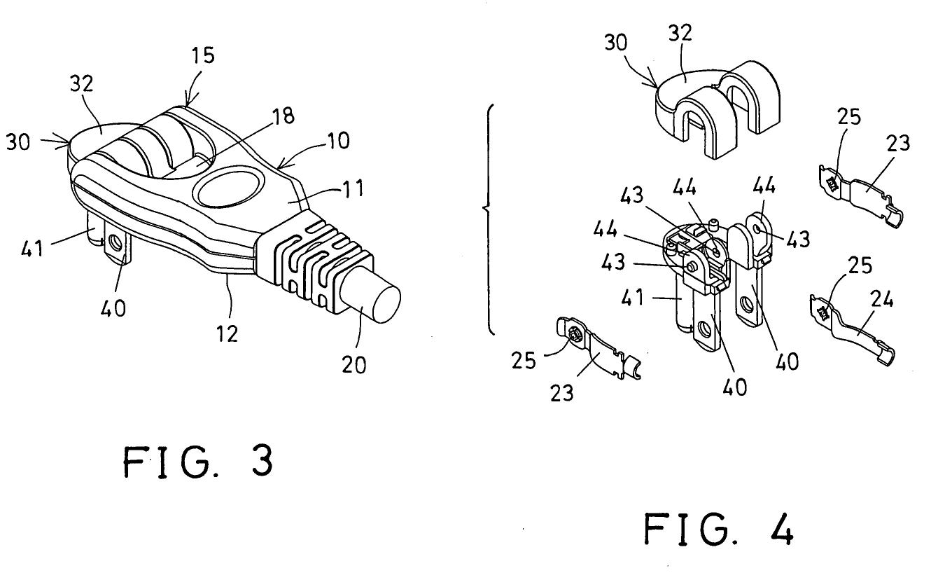

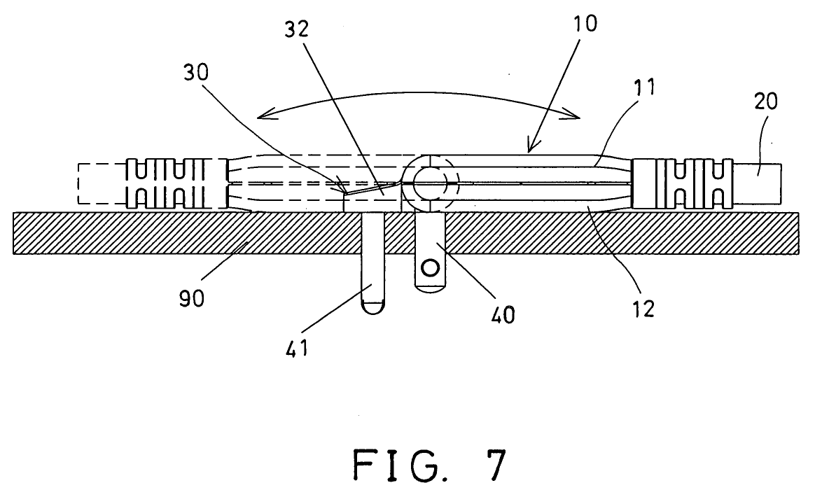

In operation, as shown in FIG. 7, the prongs 40, 41 of the casing 30 may be coupled or plugged to a socket 90, for example, and the receptacle 10 may be rotated relative to the casing 30, for allowing the electric plug to be easily plugged to various sockets at different locations. For example, the casing 30 may be rotated relative to the receptacle 10 between an outwardly extended position (FIG. 3 and solid lines in FIG. 7) and an inwardly receiving position (FIG. 6 and dotted lines in FIG. 7) where the casing 30 may be received in the recess 18 of the receptacle 10.

It is to be noted that the prong 41 and the conductor blade 24 may be optionally or selectively, but not necessarily, attached to the casing 30 and the receptacle 10 respectively, when required.

Accordingly, the electric plug in accordance with the present invention includes rotatable prongs rotatably disposed therein, for allowing the electric plug to be easily plugged to various sockets at different locations.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. An electric plug comprising:
a receptacle including two openings formed therein,
two conductor blades received in said receptacle for coupling to an electric cable,
a casing including two arms formed therein and rotatably engaged into said openings of said receptacle respectively, and
two prongs engaged in said casing, and rotatably coupled to said conductor blades respectively, to rotatably couple said casing to said receptacle, and to allow said casing to be rotated relative to said receptacle.

2. The electric plug as claimed in claim 1, wherein each of said conductor blades includes an orifice formed therein, each of said prongs includes an axle extended therefrom, and rotatably engaged into said orifices of said conductor blades, to rotatably couple said prongs to said conductor blades respectively.

3. The electric plug as claimed in claim 1, wherein said casing includes a notch formed therein, and said receptacle includes a segment rotatably engaged into said notch of said casing.

4. (canceled)

5. The electric plug as claimed in claim 1, wherein said casing further includes a third prong disposed therein and extended therefrom.

6. The electric plug as claimed in claim 5, wherein said receptacle includes a third conductor blade disposed therein and rotatably coupled to said third prong of said casing.

7. The electric plug as claimed in claim 6, wherein said third conductor blade includes an orifice formed therein, said third prong includes an axle extended therefrom, and rotatably engaged into said orifice of said third conductor blade, to rotatably couple said third prong to said third conductor blade.

8. The electric plug as claimed in claim 1, wherein said receptacle includes a recess formed therein, to receive said casing when said casing is rotated relative to said receptacle.
